(19) United States
(12) Patent Application Publication
(10) Pub. No.: US 2009/0019989 A1
(43) Pub. Date: Jan. 22, 2009

(54) Electronic Manual Display Apparatus and Method

(75) Inventors: Takashi MIZUHIKI, Hamamatsu-shi (JP); Kazuhide IWAMOTO, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 12/175,651

(22) Filed: Jul. 18, 2008

(30) Foreign Application Priority Data
Jul. 18, 2007 (JP) 2007-186864

(51) Int. Cl. G09B 15/02

(52) U.S. Cl. 84/477 R

(57) ABSTRACT

In a memory, there are stored one or more scripts including commands for controlling an electronic music apparatus, and display data for displaying a manual pertaining to the electronic music apparatus. The display data include information associating particular description portions in the manual with the one or more scripts. Manual is displayed on a display device in accordance with the display data. In response to user's designation of any one of the description portions in the manual associated with the scripts, the script, corresponding to the user-designated description portion, is transmitted to the electronic music apparatus. Each of the script corresponding to one of the description portions includes a command for causing the electronic music apparatus to automatically perform processing pertaining to the description portion, and thus, the processing pertaining to the user-designated particular description portion is automatically performed in the electronic music apparatus in accordance with the transmitted script.

### BACKGROUND

The present invention relates to electronic manual display apparatus and methods for displaying an instruction manual pertaining to a predetermined apparatus on a display device. More particularly, the present invention relates to an improved electronic manual display apparatus and method which allow a user to readily to actually operate a predetermined apparatus in accordance with a series of operating steps described in an instruction manual displayed on a display device.

Heretofore, there have been known techniques (so-called electronic manual techniques) which visually display, on a display device rather than in a booklet of paper or the like, an instruction manual containing descriptions about how to operate a multiplicity of operation members provided on an electronic music apparatus, such as an electronic musical instrument, settings that can be made on the basis of operation of the operation members, operation members necessary for performing various functions (that may be software programs) executable by the apparatus and operating steps therefor, etc. One example of such techniques is disclosed in Japanese Patent Application Laid-open Publication No. 2006-126240. The No. 2006-126240 publication discloses displaying an electronic manual technique for displaying an electronic music apparatus on a display in the form of an electronic paper. In response to a user designating or activating a desired function or the like indicated at a predetermined location of the displayed electronic manual, the display is switched to a more detailed explanation about the designated function.

In order for the user to actually operate the electronic music apparatus, the user has to appropriately select and operate desired or predetermined ones of a multiplicity of operation members provided on the music apparatus. Particularly, where the user is a beginner who has to consult the electronic manual often takes time to select desired or predetermined operators. In view of this, the above-identified publication discloses that, in response to the user touching a screen of the electronic manual to designate a desired function, illuminates (blinks) a light emitting element, such as an LED, provided within an operation member pertaining to the designated function so as to clearly indicate the operation member to be operated.

In the electronic music apparatus, there is prestored an internal program for performing simple mutually-independent control, such as control for switching the display on the display device in response to user's operation for designating a predetermined portion (i.e., “description portion” or “described content”) of the electronic manual and control for sequentially illuminating (blinking) LEDs; namely, the above-mentioned control is performed under control of the internal program. The internal program is a program prepared in advance by a maker of the music apparatus and supplied to a user, for example, after being incorporated into the music apparatus. However, because the internal program is a dedicated program described in a low-level language, such as a machine language or assembly language, interpretable and executable by the CPU of the electronic music apparatus, a human operator creating such an internal program has to have considerably-high-level programming knowledge; particularly, it is extremely difficult and time-consuming to create an internal program for performing complicated control. Further, as well known, the internal program depends on platforms, such as an architecture of the CPU and OS (Operating System) and thus has no portability. Therefore, for different (old and new) existing electronic music apparatus, different internal programs corresponding to the different versions have to be created, which would require much time and labor and tends to be extremely cumbersome. For these reasons, there has been a great demand for an improved manual display apparatus which allows not only simple independent control, such as control for merely illuminating LEDs temporarily but also complicated control for actually operating an object apparatus (i.e., apparatus to be described in a manual) in association with displayed contents on the display device, e.g. for actually operating pertinent operation members etc. in accordance with a series of operating steps described in the instruction manual displayed on the display device. No such improved electronic manual display apparatus has been proposed yet.

### SUMMARY OF THE INVENTION

In view of the foregoing, it is an object of the present invention to provide an improved electronic manual display apparatus which allows complicated control, such as control for actually operating an object apparatus to be readily performed in accordance with a series of operating steps described in an instruction manual displayed on a display device.

In order to accomplish the above-mentioned object, the present invention provides an electronic manual display apparatus, which comprises: a display device; an interface that connects an electronic music apparatus to the electronic manual display apparatus; a script storage section that stores therein one or more scripts including commands for controlling the electronic music apparatus; a manual storage section that stores therein display data for displaying a manual pertaining to the electronic music apparatus, the display data including information associating one or more particular description portions in the manual and the one or more scripts stored in the script storage section; a display control section that performs control to display a manual on the display device in accordance with the display data; and a transmission control section that, in response to user's designation of any one of the particular description portions in the manual associated with the scripts, transmits the script, corresponding to the particular description portion designated by the user, to the electronic music apparatus. Here, the script corresponding to the particular description portion includes a command for causing the electronic music apparatus to automatically perform processing pertaining to the particular description portion; thus, the processing pertaining to the particular description portion is performed in the electronic music apparatus in accordance with the transmitted script.

In an embodiment, the scripts stored in the script storage section are each a simplified program that permits automatization and facilitation of conversion into a machine language.

According to the present invention, not only the script storage section prestores therein one or more scripts including commands for controlling the electronic music apparatus, but also the manual storage section prestores therein display data, intended for displaying the manual pertaining to the electronic music apparatus, with the particular description portions in the manual associated with the scripts stored in the script storage section. In response to user's designation of any one of the particular description portions in the manual associated with the scripts, the script, corresponding to the particular description portion designated by the user, is transmitted to the electronic music apparatus. In response to the transmission of the script, the electronic music apparatus automatically performs processing corresponding to the user-designated particular description portion. Thus, by the user pointing to a desired one of the description portions of various items in the manual displayed on the display device, the electronic music apparatus, which is an object to be described by the manual, can be actually operated with ease, which is very convenient. Further, by use of the script comprising a simplified program that permits automatization and facilitation of conversion into a machine language, the inventive electronic manual display apparatus can be widely applied to old and new existing electronic music apparatus, without being influenced by the platforms of the electronic music apparatus, which is also very convenient.

The present invention may be constructed and implemented not only as the apparatus invention as discussed above but also as a method invention. Also, the present invention may be arranged and implemented as a software program for execution by a processor such as a computer or DSP, as well as a storage medium storing such a software program. Further, the processor used in the present invention may comprise a dedicated processor with dedicated logic built in hardware, not to mention a computer or other general-purpose type processor capable of running a desired software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the object and other features of the present invention, its preferred embodiments will be described hereinbelow in greater detail with reference to the accompanying drawings, in which:

FIG. 1 is a block diagram showing an example general hardware setup of an electronic manual display apparatus according to an embodiment of the present invention;

FIG. 2 is a conceptual diagram showing an example data structure of an electronic manual data set;

FIG. 3 is a functional block diagram showing an outline of a function for operating an electronic music apparatus, via the electronic manual display apparatus, in accordance with a series of operating steps described in an electronic manual;

FIG. 4 is a flow chart of an example of electronic manual display processing performed in the embodiment of the present invention;

FIG. 5 is a flow chart of an example of script transmission control processing performed in the embodiment of the present invention;

FIG. 6 is a flow chart of an example of control processing performed in the embodiment of the present invention;

FIG. 7 is a flow chart of an example of script→control interface processing performed in the embodiment of the present invention; and

FIG. 8 is a flow chart of an example of script interpretation processing performed in the embodiment of the present invention.

### DETAILED DESCRIPTION

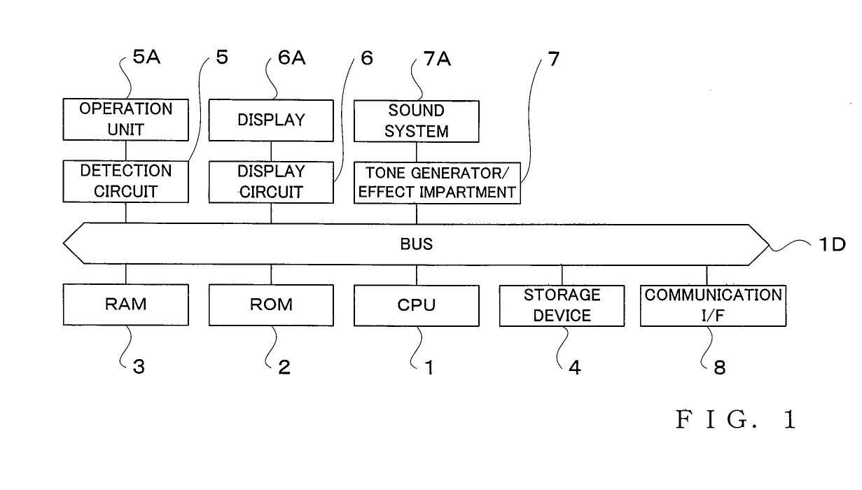

FIG. 1 is a block diagram showing an example general hardware setup of an electronic manual display apparatus according to an embodiment of the present invention. The electronic manual display apparatus is controlled by a microcomputer comprising a microprocessor unit (CPU) 1, a read-only memory (ROM) 2 and a random access memory (RAM) 3. The CPU 1 controls behavior of the entire electronic manual display apparatus. To the CPU 1 are connected, via a communication bus (e.g., data and address bus) 1D, the ROM 2, RAM 3, a storage device 4, a detection circuit 5, a display circuit 6, a tone generator/effect impartment circuit 7 and a communication interface (I/F) 8. The ROM 2 stores therein various control programs, various data, etc. to be executed or referred to by the CPU 1. The RAM 3 is used as a working memory for temporarily storing various data generated as the CPU 1 executes predetermined programs, as a memory for storing a currently-executed program and data related to the currently-executed program, and for various other purposes. Predetermined address regions of the RAM 3 are allocated to various functions and used as various registers, flags, tables, memories, etc.

The storage device 4 stores therein various control programs etc. to be executed by the CPU 1. For example, the storage device 4 stores therein sets of electronic manual data including manual display data for displaying, on the display device 6A, an electronic manual (not shown) that is an instruction manual pertaining to a predetermined apparatus, electronic-music-apparatus controlling scripts (files) each for causing the electronic music apparatus to perform a predetermined series of operations as described in the manual, etc., as will be later detailed with reference to FIG. 2. The electronic-music-apparatus controlling scripts are described in a text format in a known script language (e.g., “Perl”).

In a case where a particular control program is not stored in the ROM 2, the control program may be stored in the storage device (e.g., hard disk device) 4, so that, by reading the control program from the storage device 4 into the RAM 3, the CPU 1 is allowed to operate in exactly the same way as in the case where the particular control program is stored in the ROM 2. This arrangement greatly facilitates version upgrade of the control program, addition of a new control program, etc. The storage device 4 may use any of various removable- or non-removable-type recording media other than the hard disk (HD), such as a flexible disk (FD), compact disk (CD-ROM and/or CD-RAM), magneto-optical disk (MO) and digital versatile disk (DVD). Alternatively, the storage device 4 may comprise a semiconductor memory, such as a flash memory.

Operation unit 5A includes a switch operable by the user to give an instruction for displaying the “electronic manual” on the display device 6A, a pointing device, such as a mouse, for manipulating displayed contents on the display device 6A to, for example, switch a displayed page of the electronic manual or designate a link destination of an instruction item described in the electronic manual. The operation unit 5A may include, in place of or in addition to the aforementioned switch and pointing device, a numeric keypad for inputting numeric value data, keyboard for inputting characters and letters, and/or various other switches. The detection circuit 5 detects an operating state of the operation unit 5A and outputs switch information, corresponding to the detected operating state, to the CPU 1 via the data and address bus ID.

The display circuit 6 can display, on the display device 6A in the form of a liquid crystal display (LCD) panel, CRT, electronic paper and/or the like, an electronic manual on the basis of the later-described manual display data, as well as various data currently stored in the ROM 2 and storage device 4 and a current controlling state of the CPU 1. The tone generator/effect impartment circuit 7, which is capable of simultaneously generating tone signals in a plurality of tone generation channels, receives various performance information supplied via the communication bus ID and generates tone signals on the basis of the received performance information. The tone generator/effect impartment circuit 7 can also impart effects to the generated tone signals. Each of the tone signals generated by the tone generator/effect impartment circuit 7 is audibly reproduced or sounded via a sound system 7A including an amplifier, speaker, etc. The tone generator/effect impartment circuit 7 and sound system 7A may be constructed in any desired conventionally-known manner. For example, the tone generator/effect impartment circuit 7 may employ any of tone synthesis methods, such as the FM, PCM, physical model and formant synthesis methods. Further, the tone generator/effect impartment circuit 7 and sound system 7A may be implemented by either dedicated hardware or software processing performed by the CPU 1.

The communication interface (I/F) 8 is a data input/output interface capable of at least unilaterally communicating scripts from the electronic manual display apparatus to an external electronic music apparatus. However, the instant embodiment is not limited to this, and the communication interface 8 may also be equipped with functions as a MIDI input/output interface communicating performance data of a MIDI format and as a data input/output interface for communicating various other data and control programs than scripts. The communication interface 8 may be any of the RS-232C, USB (Universal Serial Bus), IEEE1394, Bluetooth (trademark), infrared transceiver/receiver, etc. Alternatively, the communication interface 8 may be a network interface via which the electronic manual display apparatus of the invention can be connected with external equipment (e.g., server apparatus), via a wired or wireless communication network like a LAN, Internet or telephone network, so that the manual display apparatus can communicate electronic manual data, various information, etc. with the server apparatus. It should be appreciated that the communication interface 8 may be of either or both of wired and wireless types.

The electronic manual display apparatus of the present invention is not limited to the type where all of the operation unit 5A, display device 6A, tone generator circuit/effect impartment circuit 7, etc. are incorporated together within the body of the manual display apparatus, and it may of course be of another type where the above-mentioned components 5A, 6A, 7, etc. are provided separately and interconnected via any of communication means, such as various interfaces and communication networks. Further, the electronic manual display apparatus of the present invention is not limited to the aforementioned computer form and may be applied to any desired form of apparatus or equipment, such as an electronic musical instrument, karaoke apparatus, game apparatus, portable communication terminal like a portable phone, player piano, or the like. In the case where the inventive electronic manual display apparatus is applied to a portable communication terminal, part of the necessary functions may be performed by a server computer, instead of all of the necessary functions being performed by the portable communication terminal alone, so that all of the necessary functions are realized by an entire system comprising the communication terminal and server computer.

Whereas the electronic music apparatus connected with the electronic manual display apparatus of the present invention via the communication interface 8 may be constructed using the same hardware setup as the electronic manual display apparatus, it may be constructed an electronic musical instrument that includes a performance operation unit, such as a keyboard having a plurality of keys for selecting desired tone pitches, light emitting elements, such as LEDs, provided within or near the individual performance operation members. Alternatively, the electronic music apparatus may be constructed as a mixer that includes a mixing circuit and operation members, such as faders, for controlling the mixing circuit.

Next, with reference to FIG. 2, a description will be given about the electronic manual data sets stored in the storage device 4. FIG. 2 is a conceptual diagram showing an example data structure of one of the electronic manual data sets. Broadly stated, the electronic manual data set includes manual display data, scripts and script transmitting scrip. Specifically, different electronic manual data sets, such as those created in advance and preset by makers of electronic music apparatus and created by the user, are prestored in association with the makers and models of the music apparatus to be described by the displayed manual (i.e., “object apparatus”).

The manual display data are data including, for example, document texts, images (still images and moving images), etc. for displaying an “electronic manual” which is an instruction manual describing how to operate operation members of the electronic music apparatus and settings of the operation members and operating steps for performing various function, etc. In FIG. 2, there are shown manual display data for displaying an “electronic manual” pertaining to operating steps for performing “function A”, and the manual display data include “function A title data” indicative of a unique name assigned to “function A” and “function A-1 describing data” and “function A-2 describing data” for displaying descriptions about “function A-1” and “function A-2”, respectively. The manual display data also include definition information pertaining to link destinations; more specifically, stored locations of scripts are stored as such definition information pertaining to link destinations.

The “script” is a general-purpose simplified program described in a text format in a known script language (e.g., “Perl”), which does not depend on platforms. As known in the art, the “script” permits automatization and facilitation of conversion from a script language (e.g., “Perl”), i.e. general-purpose simplified programming language, into a machine language. “entire function A script” is a program where is described a series of operating steps (commands) for performing entire predetermined “function A”, from the beginning to the end thereof, just as described in the electronic manual. “function A-1 script” and “function A-2 script” are programs prepared for segmentized functions of “function A”, in each of which is described a series of operating steps (commands) for performing only the corresponding segmentized function just as described in the electronic manual.

The following lines describe example contents of a program of a script defined as a link destination in manual display data. In the illustrated example, the script corresponds to the manual display data describing operating steps for performing a function of reproducing a demo song, and that the script is designed to control the electronic music apparatus to sequentially perform the operating steps, intended for reproducing a demo song displayed in an electronic manual, which comprise depressing a “Song Button”, depressing a “Play Button” and depressing a “Stop Button” (script language is “Perl”).

(Example of Script)

#!/usr/bin/perl

#depress Song Button (select a demo song)

print “onoff Button/Song¥n”;

#depress Play Button (start reproduction of the demo song)

print “onoff Button/SeqTransport/ Play¥n”;

wait for 10 minute (with the reproduction continued) sleep 10;

#depress Stop Button (stop the reproduction of the demo song) print “onoff Button/SeqTransport/ Stop¥”;

Because control instructions for controlling and instructing the electronic music apparatus can not of course be directly described in the script, commands in the script language are described as alternative commands. In the aforementioned example of script, each “print” command followed by a text is used in place of a command for depressing a button in the electronic music apparatus. Note that commands in the script language usable as alternative commands are determined in a “command conversion table” that will be explained here later.

In each of the one or more scripts, there is described a combination of: one or more alternative commands (print command in the above-mentioned example) for realizing a series of operations corresponding to a function of the electronic music apparatus, connected to the electronic manual display apparatus; and an alternative wait command (sleep command in the above-mentioned example) for securing a time necessary for the electronic music apparatus to perform the series of operations.

Script defined as a link destination in the manual display data can be freely created by the user describing it in a text format in the electronic manual display apparatus, and a multiplicity of the thus-created scripts can be stored in the storage device 4. Namely, the electronic manual display apparatus itself has a programming environment, such as an edit function for describing a script, so that each script programmed by the user can be stored as-is (or directly) into the storage device 4. Further, the electronic manual display apparatus may be constructed to store a scripts supplied from the maker of the electronic music apparatus, into the electronic manual display apparatus. For example, the electronic manual display apparatus may be constructed to download and store a script, supplied from maker or created by another user, via a server apparatus on a network, or load and store a script from a removable storage medium.

Referring back to FIG. 2, the “script transmitting scrip” is a program for performing control to detect which one of items (individual functions and segmentized functions having link destinations defined therefor) in the “electronic manual” has been designated, then read out, from the storage device 4 (later-described “electronic manual storage section Z” of FIG. 3), a script defined as a link destination of the designated item and then transmit the read-out script to the electronic music apparatus.

Next, a description will be given about the outline of the function for actually operating the electronic music apparatus in accordance with a series of operating steps described in the electronic manual. FIG. 3 is a functional block diagram showing the outline of the function for operating the electronic music apparatus, via the electronic manual display apparatus, in accordance with the series of operating steps described in the electronic manual.

In the electronic manual display apparatus P, the electronic manual storage section Z stores therein electronic manual data (see FIG. 2). Once an operation section G (operation unit 5A) is operated by the user to instruct that an “electronic manual” be displayed, a control section Y (CPU 1) reads out, from the electronic manual storage section Z, the electronic manual data set corresponding to the electronic music apparatus and then displays the “electronic manual” on a display section H on the basis of manual display data included in the read-out electronic manual data. Once any one item having a link destination defined therefor is designated on the electronic manual displayed on the display section H in response to the user's operation, not only a page having a further detailed description about the link destination is displayed on the display section H, but also a script defined as the link destination of the designated item is found from the read-out electronic manual data and the found script is transmitted to the electronic music apparatus DM. Such an operation is performed by the control section Y executing the script transmitting script.

Needless to say, the electronic manual display apparatus P may be constructed to not only edit or newly create a program of a script and manual display data, but also define correspondency between them (namely, define a link destination). In editing/creating a script, it is necessary for the user to select and describe an alternative command, corresponding to an internal command for performing a user-desired process, from among a multiplicity of alternative commands registered in a predetermined library (command conversion table) supplied from the maker and already stored in the electronic manual display apparatus.

On the other hand, once an operation section A (operation unit 5A, performance operation unit, etc.) is operated in the electronic music apparatus DM, a control section X (CPU 1) instructs a display section B (display device 6A, LED, etc.) to change the displayed content of each related item and/or instructs a tone generator section C (tone generator/effect impartment circuit 7) to control a tone signal to be generated, in accordance with operational styles, amounts, etc. Needless to say, such operations are carried out in accordance with an internal program (i.e., non-script program) supplied by the maker and prestored in the electronic music apparatus and directly interpretable and executable by the CPU 1.

Once a script is transmitted from the electronic manual display apparatus P to the electronic music apparatus DM, a script storage section V of the electronic music apparatus DM receives and stores therein the transmitted script. Script execution section O is a conventionally-known general-purpose script execution engine, which is a software program that may include a compiler and linker or an interpreter although not shown, interprets and executes the script received from the electronic manual display apparatus P and stored in the script storage section V. Needless to say, the OS of the electronic music apparatus DM is an OS capable of running the script execution engine. In other words, a general-purpose script execution engine that can be run by the OS of the electronic music apparatus DM is installed in the electronic music apparatus DM. As an example, the script execution engine installed in the electronic music apparatus DM is “Perl” while the OS is a UNIX-family OS, although they are not necessarily so limited. As set forth above, the script has electronic-music-apparatus controlling commands described therein for controlling the electronic music apparatus to perform a series of operating steps necessary for a function displayed in the electronic manual. The script comprises commands of the script language which are used as alternative commands for controlling the electronic music apparatus. Thus, even if a script-language command (e.g., print command) is transmitted to the control section X as a control instruction (e.g., control instruction instructing depression of a button) as the script is executed, the control section X can not interpret such a command as-is and thus can not perform the desired control. Namely, even if the script execution section O executes the script, the electronic music apparatus can not be controlled directly in accordance with the script as-is.

Thus, a control-script interface (I/F) section I is provided between the control section X and the script execution section O. The control-script interface section I performs conversion into instruction/data formats that can be handled by the script execution section O and control section X, respectively. To perform the conversion of the instruction format, the command conversion table (or interpreter) (not shown) is consulted. The command conversion table comprises data indicative of correspondency between commands of the script language and internal commands necessary for conversion of interpretable/executable electronic-music-apparatus controlling commands (i.e., alternative commands described in the script language) into internal commands (described in the machine language) directly interpretable/executable by the CPU 1 as the general-purpose script execution engine executes a script. The command conversion table is supplied and prestored in advance as a library specific to the electronic manual display apparatus. Of course, the contents of such a command conversion table may be modified/created as desired by the user.

Namely, the control-script interface section I refers to the command conversion table or the like to convert an interpretable/executable electronic-music-apparatus controlling command (alternative command), described in the script language, into an internal command directly interpretable/executable by the CPU 1. With such conversion of the instruction/data format, the control section X can control the operation section A, display section B and tone generator section C, i.e. can control behavior of the electronic music apparatus, in response to execution, by the script execution section O, of the script. Of course, any other form of command conversion means than the “command conversion table” may be used, as long as it permits appropriate conversion between the internal management scheme where instructions/data are managed in the instruction/data format (e.g., binary notation) directly interpretable/executable by the CPU 1 and the script management scheme where instructions/data are managed in the instruction/data format (e.g., decimal notation) interpretable/executable by the general-purpose script execution engine on the basis of a predetermined script, so as to achieve agreement between the two management schemes.

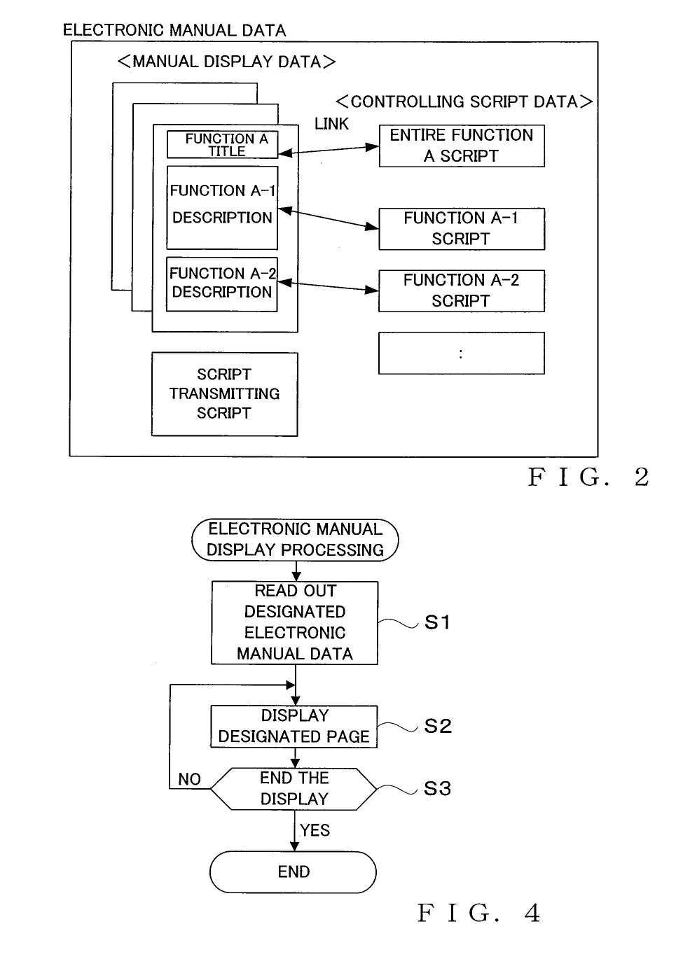

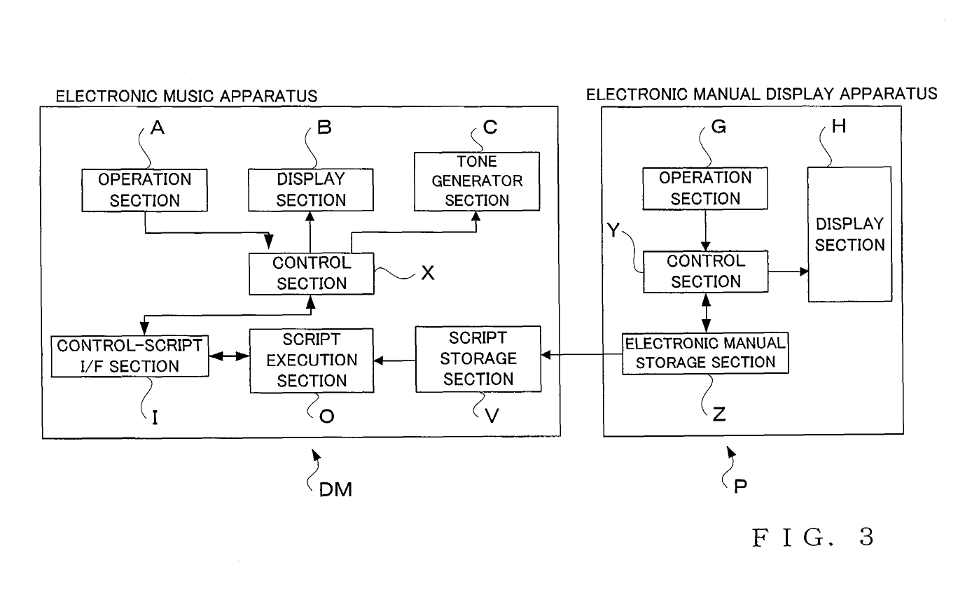

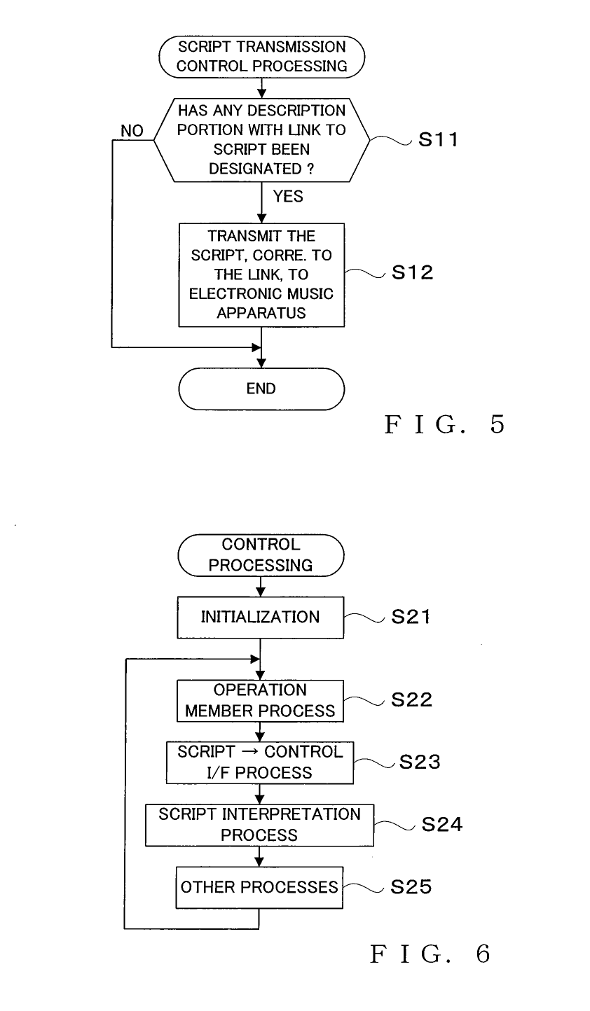

With reference to FIGS. 4-8, the following paragraphs describe function for operating the electronic music apparatus in accordance with the series of operating steps described in the electronic manual. FIGS. 4 and 5 shows processing performed in the electronic manual display apparatus, while FIGS. 6-8 shows processing performed in the electronic music apparatus.

FIG. 4 is a flow chart of an example of “electronic manual display processing” for displaying an electronic manual on the display device 6A. At step S1, an electronic manual data set pertaining to the electronic music apparatus, for which the user has instructed that an electronic manual be displayed, is read out from the storage device 4 into the RAM 3. At next step S2, a page describing a function designated for reference by the user is displayed on the display device 6A on the basis of the corresponding manual display data (e.g., function A-1 describing data). At following step S3, a determination is made as to whether or not the display of the electronic manual is to be ended in response to user's operation. If an instruction for ending the display of the electronic manual has been given (YES determination at step S3), the display of the electronic manual is ended, upon which the instant processing is brought to an end. In this case, the display of the electronic manual is switched to another desired screen. If, on the other hand, no instruction for ending the display of the electronic manual has been given (NO determination at step S3), control reverts to step S2 to continue the display of the electronic manual.

FIG. 5 is a flow chart of an example of “script transmission control processing” for detecting user's designation of a link destination on the electronic manual and transmitting to the electronic music apparatus a script that is the designated link destination. This script transmission control processing is based on the described contents of the script transmitting script. Namely, when the electronic manual data set is read out in the electronic manual display processing of FIG. 4, the script transmitting script is read out simultaneously with the readout of the electronic manual data set, and the general-purpose script execution engine (not shown) executes the script. At step S11, a determination is made as to whether any one of predetermined description portions, pertaining to functions (items) etc. having respective links added thereto, has been designated by the user. With a YES determination at step S11, the script of the link destination is transmitted to the electronic music apparatus connected to the electronic manual display apparatus via the communication interface 8, at step S12. More specifically, when the electronic music apparatus corresponding to the electronic manual has been found from among various pieces of equipment connected to the electronic manual display apparatus via the communication interface 8, the electronic manual display apparatus transmits the script to the electronic music apparatus. In case no apparatus corresponding to the electronic manual has been found from among the various equipment, the script is not transmitted. Note that the script is contained in the electronic manual data set having been read into the RAM 3 (see step S1).

Whereas the instant embodiment has been described above as detecting user's designation, on the electronic manual, of any one of the predetermined description portions pertaining to functions (items) etc. having respective links added thereto, by use of the script transmitting script contained in the electronic manual data set prestored in the storage device 4 (see FIG. 2). However, the present invention is not so limited. For example, such user's designation, on the electronic manual, of any one of the predetermined description portions may be detected as a partial process of the electronic manual display processing shown in FIG. 4, or by use of an extended program (that is not a script) assisting the electronic manual display processing. Further, the present invention is not limited to the embodiment where both the user's designation detection and the script transmission are performed by means of one script, extended program, etc.; both the user's designation detection and the script transmission may be performed separately by a respective script, extended program, etc.

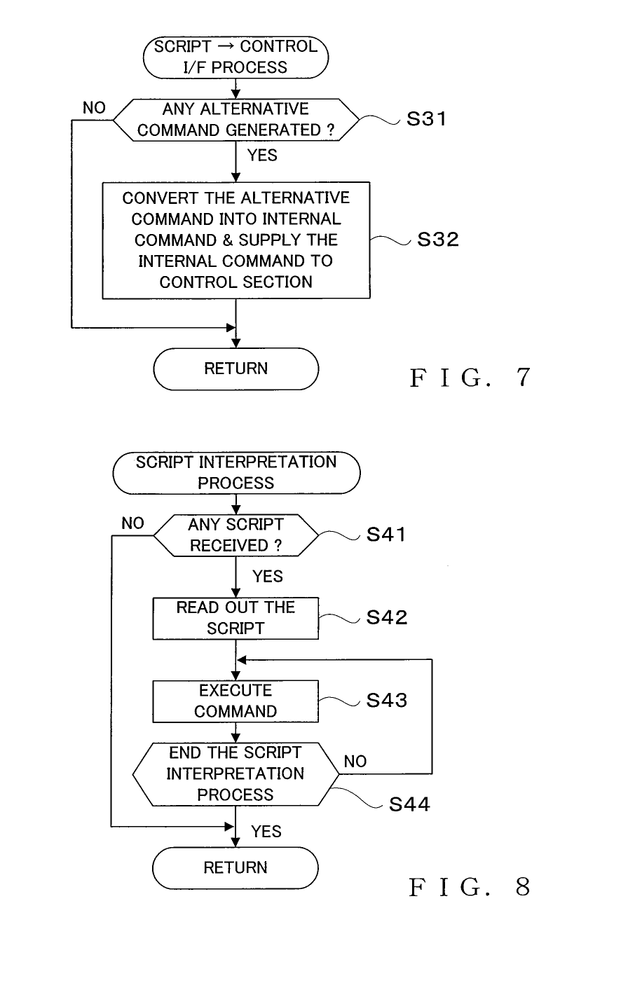

FIG. 6 is a flow chart of an example of “control processing” for controlling the behavior of the electronic music apparatus DM. The control processing is started up by the CPU 1 upon powering-on of the electronic music apparatus DM, and it corresponds to the function of the control section X. At step S21, a predetermined initialization process is performed, which includes clearing, initial setting, etc. of registers among others. More specifically, the predetermined initialization process includes clearing of native code corresponding to the last-executed script, initialization of various operating and setting states of the electronic music apparatus DM, etc. At next step S22, an “operation member process” is performed, where conventionally-known processes originally associated with the individual operation members are performed; for example, in this operation member process, control is performed for setting parameter values pertaining to tone control, such as tone color and effect, generating note event data, including a note number associated with an operated key, and then audibly producing a tone on the basis of the note event data. Of course, such originally-associated processes are performed in accordance with the internal program (that is a non-script program) supplied and prestored in advance in the electronic music apparatus DM by the maker. At step S23, a “script→control interface process” is performed (see FIG. 7). At following step S24, a “script interpretation process” is performed (see FIG. 8). At step S25, “other processes” are performed.

FIG. 7 is a flow chart of an example of the “script→control interface processing” (see step S23 of FIG. 6). This process corresponds to the function of the control-script interface section I. At step S31, a determination is made as to whether any alternative command, which is an electronic-music-apparatus controlling command, has been generated as the script execution section executes a script. With a YES determination at step at step S31, the alternative command is converted into an internal command by the control-script interface section I, and the internal command is supplied to the control section X, at step S32. Namely, the CPU 1 refers to the “command conversion table” to convert an interpretable/executable alternative command, described in the script, into an electronic-music-apparatus controlling internal command directly interpretable/executable by the CPU 1. In this way, the CPU 1 can monitor the script execution by the script execution section O and control the electronic music apparatus in response to generation of the alternative command.

FIG. 8 is a flow chart of an example of “script interpretation processing” (see step S24 of FIG. 6). This script interpretation processing corresponds to the function of the script execution section O. At step 41, a determination is made as to whether any script has been received from the electronic manual display apparatus. If no script has been received (NO determination at step S41), the script interpretation processing is brought to an end. If, on the other hand, some script has been received (YES determination at step S41), the script is read out from the script storage section V into the script execution section (general-purpose script execution engine) 0, and the read-out script is compiled before execution.

The script execution section (general-purpose script execution engine) 0 interprets the read-out script and executes a command at step S43 if the interpreted content is a command. At that time, if the interpreted content is an alternative content that is no directly interpretable by the control section X (CPU 1), then the command conversion is carried out in the aforementioned manner, so that the converted command is supplied to the control section X (see step S32 of FIG. 7). If, on the other hand, the interpreted content is a command directly executable by the control section X, the command is supplied directly to the control section X without the command conversion being performed. Further, if the interpreted content is neither an alternative command nor a command directly interpretable by the control section X, then the command may be ignored without being supplied to the control section X. At step S44, a determination is made as to whether the entire series of operations based on the command described in the script has been completed. With a YES determination at step S44, the instant processing is brought to an end. If the entire series of operations has not been completed (NO determination at step S44), control reverts to step S43 so that the operations continue to be sequentially performed in accordance with the command described in the script.

As set forth above, there are prestored one or more scripts each of which is a simplified program that permits automatization and facilitation of the conversion into the machine language and includes a command for controlling the electronic music apparatus. In response to detection of user's designation, on a currently-displayed electronic manual, of any one of the description portions (described contents) associated with the scripts, the script corresponding to the designated description portion is transmitted to the electronic music apparatus. In response to the script transmitted from the electronic manual display apparatus, the electronic music apparatus interprets and executes the script and automatically performs a series of operations based on the description portion being displayed on the display device. In this way, the electronic music apparatus can be actually operated with ease in accordance with a series of operating steps described in the displayed electronic manual.

The electronic music apparatus DM may include an automatic operation mechanism via which the individual operation members are automatically moved to predetermined designated positions in response to execution of a script.

According to the present invention, it is also possible to facilitate automatic initialization of the electronic music apparatus in accordance with a series of operating steps described in an electronic manual. Namely, initial setting information is described in advance in a script of a link destination (in other words, an initially setting script is created in advance), so that the script defined as the link destination is executed in response to user's designating operation on the electronic manual displayed on the display 6A. Thus, even a beginner user or the like, who is unaccustomed to operation of the electronic music apparatus, allows initialization of the electronic music apparatus to be performed automatically while confirming operating steps, by merely designating a link destination in accordance with the displayed electronic manual, without the user itself performing setting operation as by operating predetermined operation members.

This application is based on, and claims priority to, JP PA 2007-186864 filed on 18 Jul. 2007. The disclosure of the priority applications, in its entirety, including the drawings, claims, and the specification thereof, is incorporated herein by reference.

What is claimed is:

1. An electronic manual display apparatus comprising:
a display device;
an interface that connects an electronic music apparatus to said electronic manual display apparatus;
a script storage section that stores therein one or more scripts including commands for controlling the electronic music apparatus;
a manual storage section that stores therein display data for displaying a manual pertaining to the electronic music apparatus, the display data including information associating one or more particular description portions in the manual and the one or more scripts stored in said script storage section;
a display control section that performs control to display a manual on said display device in accordance with the display data; and
a transmission control section that, in response to user's designation of any one of the particular description portions in the manual associated with the scripts, transmits the script, corresponding to the particular description portion designated by the user, to the electronic music apparatus,
wherein the script corresponding to the particular description portion includes a command for causing the electronic music apparatus to automatically perform processing pertaining to the particular description portion, whereby the processing pertaining to the particular description portion designated by the user is performed in the electronic music apparatus in accordance with the transmitted script.

2. The electronic manual display apparatus as claimed in claim 1 wherein the scripts stored in said script storage section are each a simplified program that permits automatization and facilitation of conversion into a machine language.

3. The electronic manual display apparatus as claimed in claim 1 wherein said script storage section stores therein one or more scripts in each of which are described a combination of one or more commands for realizing a series of operations corresponding to a function of the electronic music apparatus connected to said electronic manual display apparatus and a wait command for securing a time necessary for the electronic music apparatus to perform the series of operations.

4. The electronic manual display apparatus as claimed in claim 3 wherein said one or more commands for realizing a series of operations corresponding to a function of the electronic music apparatus includes a command for selecting a particular music piece, a command for starting reproduction of the particular music piece and a command for ending the reproduction of the particular music piece, and wherein said wait command is for setting a reproduction time length from a start to end of the reproduction of the particular music piece.

5. The electronic manual display apparatus as claimed in claim 1 wherein the processing pertaining to the particular description portion includes an operation for achieving a state equivalent to turning-on of a particular switch provided on the electronic music apparatus.

6. The electronic manual display apparatus as claimed in claim 1 wherein each of the scripts is based on a general-purpose script language and described in a text format.

7. The electronic manual display apparatus as claimed in claim 1 wherein said display data include links to the one more scripts stored in said script storage section in association with the one or more particular description portions in the manual, and
the user's designation of any one of the particular description portions is operation for designating, via a pointing device, the particular description portion having the link added thereto.

8. The electronic manual display apparatus as claimed in claim 1 wherein said display data stored in said manual storage section further include a transmitting script for transmitting the script, corresponding to the particular description portion, to the electronic music apparatus, and
said transmission control section executes the transmitting script to thereby transmit the script, corresponding to the particular description portion, to the electronic music apparatus.

9. An electronic music apparatus connectable to an electronic manual display apparatus that is capable of generating one or more scripts each including a command for controlling said electronic music apparatus, said electronic music apparatus comprising:
an interface that connects the electronic manual display apparatus to said electronic music apparatus;
a main control section that operates said electronic music apparatus on the basis of an internal command of a predetermined data format that is an interpretable and executable control instruction;
a script reception section that receives a script transmitted from said electronic manual display apparatus via said interface;
a script execution section that interprets and executes the script received by said electronic manual display apparatus; and
a conversion section that, in response to interpretation and execution by said script execution section of the received script, converts the command, described in the script, into an internal command of the predetermined data format that is interpretable and executable by said main control section,
wherein the processing pertaining to the particular description portion designated by the user is automatically performed by said electronic music apparatus on the basis of the command converted by said conversion section.

10. The electronic music apparatus as claimed in claim 9 wherein said conversion section includes an interface for converting a command of a script language into an internal command of said electronic music apparatus.

11. A system for electronically displaying a manual, comprising an electronic manual display apparatus and an electronic music apparatus,
(a) said electronic manual display apparatus comprising:
a display device;
an interface that connects the electronic music apparatus to said electronic manual display apparatus;
a script storage section that stores therein one or more scripts including commands for controlling the electronic music apparatus;
a manual storage section that stores therein display data for displaying a manual pertaining to the electronic music apparatus, the display data including information associating one or more particular description portions in the manual and the one or more scripts stored in said script storage section;
a display control section that performs control to display a manual on said display device in accordance with the display data; and
a transmission control section that, in response to user's designation of any one of the particular description portions in the manual associated with the scripts, transmits the script, corresponding to the particular description portion designated by the user, to the electronic music apparatus,
wherein the script corresponding to the particular description portion includes a command for causing the electronic music apparatus to automatically perform processing pertaining to the particular description portion,
(b) said electronic music apparatus comprising:
an interface that connects the electronic manual display apparatus to said electronic music apparatus;
a main control section that operates said electronic music apparatus on the basis of an internal command of a predetermined data format that is an interpretable and executable control instruction;
a script reception section that receives a script transmitted from said electronic manual display apparatus via said interface;
a script execution section that interprets and executes the script received by said electronic manual display apparatus; and
a conversion section that, in response to interpretation and execution by said script execution section of the received script, converts the command, described in the script, into an internal command of the predetermined data format that is interpretable and executable by said main control section,
wherein the processing pertaining to the particular description portion designated by the user is automatically performed by said electronic music apparatus on the basis of the command converted by said conversion section.

12. The system as claimed in claim 11 wherein the scripts stored in said script storage section are each a simplified program that permits automatization and facilitation of conversion into a machine language.

13. The system as claimed in claim 11 wherein said conversion section includes an interface for converting a command of a script language into an internal command of said electronic music apparatus.

14. A computer-implemented method for electronically displaying a manual pertaining to an electronic music apparatus by use of a display device attached to a computer, said method comprising:
connecting the electronic music apparatus to the computer;
providing a script storage section that stores therein one or more scripts including commands for controlling the electronic music apparatus;
providing a manual storage section that stores therein display data for displaying a manual pertaining to the electronic music apparatus, the display data including information associating one or more particular description portions in the manual and the one or more scripts stored in said script storage section;
displaying a manual on the display device in accordance with the display data;
detecting user's designation of any one of the particular description portions in the manual associated with the scripts; and
in response to detection of the user's designation, reading out from the script storage section the script, corresponding to the particular description portion designated by the user, and transmitting the read-out script to said electronic music apparatus,
wherein the script corresponding to the particular description portion includes a command for causing the electronic music apparatus to automatically perform processing pertaining to the particular description portion, whereby the processing pertaining to the particular description portion designated by the user is automatically performed in the electronic music apparatus in accordance with the transmitted script.

15. The method as claimed in claim 14 wherein the scripts stored in said script storage section are each a simplified program that permits automatization and facilitation of conversion into a machine language.

16. The method as claimed in claim 14 which further comprises:
said electronic music apparatus receiving the transmitted script;
said electronic music apparatus interpreting and executing the received script; and
in response to interpretation and execution of the received script, said electronic music apparatus converting the command, described in the script, into an internal command of a predetermined data format that is interpretable and executable by a main control section of said music apparatus,
wherein the processing pertaining to the particular description portion designated by the user is automatically performed by said electronic music apparatus on the basis of the converted command.

17. A computer-readable medium containing a group of instructions for causing a computer to perform a procedure for electronically displaying a manual pertaining to an electronic music apparatus by use of a display device attached to a computer, said computer having attached thereto a script storage section that stores therein one or more scripts including commands for controlling the electronic music apparatus and a manual storage section that stores therein display data for displaying a manual pertaining to the electronic music apparatus, said procedure comprising:
providing an interface that connects the electronic music apparatus to the computer;
displaying a manual on the display device in accordance with the display data;
detecting user's designation of any one of the particular description portions in the manual associated with the scripts; and
in response to detection of the user's designation, reading out from the script storage section the script, corresponding to the particular description portion designated by the user, and transmitting the read-out script to said electronic music apparatus,
wherein the script corresponding to the particular description portion includes a command for causing the electronic music apparatus to automatically perform processing pertaining to the particular description portion, whereby the processing pertaining to the particular description portion designated by the user is automatically performed in the electronic music apparatus in accordance with the transmitted script.

18. The computer-readable medium as claimed in claim 17 wherein the scripts stored in said script storage section are each a simplified program that permits automatization and facilitation of conversion into a machine language.
